(19) United States
(12) Patent Application Publication
(10) Pub. No.: US 2009/0310466 A1
(43) Pub. Date: Dec. 17, 2009

(54) OBJECTIVE LENS DRIVING DEVICE AND DRIVING METHOD FOR THE SAME

(75) Inventors: Yoshimichi Nishio, Kawagoe-shi (JP); Chikashi Kuwahara, Kawagoe-shi (JP); Takaaki Ujiie, Kawagoe-shi (JP); Hiroshi Someya, Kawagoe-shi (JP); Hidetaka Urabe, Kawagoe-shi (JP); Yoshihiro Hashizuka, Kawagoe-shi (JP); Hideyasu Iwano, Kawagoe-shi (JP); Hiroyuki Enomoto, Kawagoe-shi (JP); Hideaki Tsurumi, Kawagoe-shi (JP); Manabu Shimodaira, Kawagoe-shi (JP)

Correspondence Address: SUGHRUE MION, PLLC, 2100 PENNSYLVANIA AVENUE, N.W., SUITE 800, WASHINGTON, DC, 20037, US

(73) Assignee: Pioneer Corporation, Meguro-ku, Tokyo (JP)

(21) Appl. No.: 12/096,108

(22) PCT Filed: Dec. 8, 2006
(86) PCT No.: PCT/JP2006/324534

§ 371 Date: May 6, 2009

(30) Foreign Application Priority Data
Dec. 15, 2005 (JP) 2005-361485

(51) Int. Cl. G11B 7/135

(52) U.S. Cl. 369/112.23; G9B/7.112

(57) ABSTRACT

[Problems] In an objective lens driving device used for an optical disc and the like, a moving speed of the objective lens is changed corresponding to amount of vertical deviation of the optical disc, and when the vertical deviation is small, time for aligning the focus is reduced.

[Means for Solving Problems] In a case that an objective lens is moved from a bottom limit to an upper limit in a specific range for aligning the focus, when the objective lens is positioned nearer a point (basic focusing position) where light is focused on an optical disc 11 having no vertical deviation than a position away from the basic focusing position, the servo signal processor 5 moves the objective lens faster.

### TECHNICAL FIELD

This invention relates to an objective lens driving device and a driving method for the objective lens which is used for an optical disc reproducing device.

### BACKGROUND

In the optical disc reproducing device, it is necessary to align a focus of the objective lens on a recording surface of an optical disc (hereafter referred to as align the focus) before reproducing the optical disc. In view of usage environmental changes of the reproducing device, and changes of relative speed between the optical disc and the objective lens due to a vertical deviation of the optical disc caused by warpage of the optical disc or distortion of a signal surface, driving speed of the objective lens is fixed to a predetermined speed, so that even at worst aligning the focus may be carried out.

However, in this case, even when the change of the relative speed between the optical disc and the objective lens is small, namely, the vertical deviation is small, unnecessary time is spent for aligning the focus because the driving speed of the objective lens is set to the worst condition. To solve this problem, Patent document 1 discloses a method for changing driving speed of the objective lens upon aligning the focus based on duration of detecting a focus error signal.

[Patent Document 1] Japanese Published Patent Application No. 2004-14091

### DISCLOSURE OF THE INVENTION

### Problem to be Solved by the Invention

According to the method disclosed in Patent Document 1, the relative speed depends on where of the vertical deviation the focus error is measured when the optical disc to be reproduced has vertical deviation, namely, whether the focus error is measured when the optical disc is moved close to the objective lens or away from the objective lens. Therefore, there is a problem that sometimes the driving speed is different from the normal driving speed. Therefore, when failing to align the focus, aligning the focus is repeated. Resultingly, sometimes unnecessary time is spent for aligning the focus.

Accordingly, an object of the present invention is to provide an objective lens driving device and a method for driving the objective lens to reduce time for aligning the focus when the vertical deviation is small by setting the driving speed of the objective lens corresponding to the amount of the vertical deviation when the optical disc to be reproduced has the vertical deviation.

### Means for Solving Problem

For attaining the object, according to claim 1 of the present invention, there is provided an objective lens driving device including:

a light source;

an objective lens for focusing light from the light source on an optical disc;

a driving member for moving the objective lens with respect to the optical lens in a substantially vertical direction,

a controlling member for allowing the driving member to move the objective lens in a specific range so as to align the focus to focus light from the light source on the optical disc,

wherein when aligning the focus, the control member controls the driving member to move the objective lens faster as the objective lens is positioned closer to a basic focusing position at which the light is focused on the optical disc having no vertical deviation.

According to claim 7 of the present invention, there is provided an objective lens driving method for moving an objective lens with respect to an optical disc in a substantially vertical direction, said objective lens being used for focusing light from a light source on the optical disc,

wherein when aligning the focus to move the objective lens in a specific range so as to focus the light from the light source on the optical disc, the objective lens is allowed to move faster as the objective lens is positioned closer to a basic focusing position at which the light is focused on the optical disc having no vertical deviation.

### BRIEF DESCRIPTION OF DRAWINGS

FIG. 1 A block diagram showing an optical disc player according to first and second embodiments of the present invention.

FIG. 2 A flowchart showing an aligning a focus operation of the optical disc player shown in FIG. 1 according to the first embodiment.

FIGS. 3A, 3B, 3C Explanatory views showing a relationship among an objective lens, a focusing position of light emitted from the objective lens, and a signal surface when aligning the focus.

FIG. 4 An explanatory view showing a waveform of an focus error signal.

FIG. 5 A flowchart showing an operation when aligning the focus again after carrying out the flowchart of FIG. 3.

FIG. 6 A flowchart showing an operation of aligning the focus of the optical disc player shown in FIG. 1 according to the second embodiment.

FIG. 7 An explanatory view showing a relationship among an objective lens, a focusing position of light emitted from the objective lens, and a signal surface when aligning the focus according to the second embodiment.

### EXPLANATIONS OF LETTERS OR NUMERALS

1 optical disc player (objective lens driving device)
3 optical pickup (light source, objective lens)
5 servo signal processing member (driving device, controlling device, memorizing device)
11 optical disc
S101 to move the objective lens from the bottom end to the focusing position when the optical disc has no vertical deviation
S106 to change moving speed of the objective lens
S108 to move the objective lens from the top end at low speed
S112 to save the aligning speed to RAM (memorizing member)
S152 to move the objective lens at the speed reed out from RAM
S157 to move the objective lens in reverse direction at low speed
S161 to save the aligning speed to RAM (memorizing member)
S106′ to change moving speed of the objective lens
hb boundary point
hb′ boundary point
h0 lower limit of the specific range to move the objective lens
h1 upper limit of the specific range to move the objective lens

### BEST MODE FOR CARRYING OUT THE INVENTION

Hereafter, an objective lens driving device according to a first embodiment of the present invention will be explained. The objective lens driving device according to the first embodiment of the present invention is so controlled as to move the objective lens faster as the objective lens is positioned closer to the basic focusing position at which light is focused on the optical disc having no vertical deviation. Thus, in a position away from the basic focusing position when the optical disc has no vertical deviation, namely, in a position where a possibility to detect the focusing position when the optical disc has a large vertical deviation, the objective lens is allowed to move so slowly as to align the focus even when the optical disc has the large vertical deviation. In a position near the focusing position when the optical disc has no jiggle, namely, in a position where a possibility to detect the focusing position when the optical disc has a small jiggle, the objective lens is allowed to move so fast as to align the focus when the optical disc has a small vertical deviation. Therefore, the objective lens driving device can align the focus at a speed corresponding to an amount of the vertical deviation. Therefore, when the vertical deviation is small, time for aligning the focus can be reduced.

When the objective lens is moved away from the basic focusing position, a controlling member can control to move the objective lens slower as the objective lens is positioned further from the basic focusing position. Thus, because the objective lens is moved slower as the objective lens is positioned further from the basic focusing position, when the vertical deviation is small, the objective lens can be moved at a high speed, and the time for aligning the focus can be reduced.

The controlling member may set a boundary point in a specific range to move the objective lens. When the objective lens is nearer the basic focusing position than the boundary point, the controller may control to move the objective lens faster than when the objective lens is further the basic focusing position than the boundary point. Namely, the boundary point is set at a point where it is possible to align the focus even when the objective lens is moved at high speed due to the small vertical deviation. The objective lens is moved at high speed at the point nearer the basic focusing position than the boundary point. The objective lens is moved at low speed at the point further the basic focusing position than the boundary point. Thus, the moving speed of the objective lens can be changed corresponding to the amount of the vertical deviation.

The controlling member may set a plurality of boundary points, and as the objective lens is moved through one of the boundary points toward the basic focusing position, the controlling member may move the objective lens faster. Thus, the moving speed of the objective lens corresponds to the amount of the vertical deviation.

The objective lens driving device may include a memorizing member to memorize the moving speed of the objective lens when the light is focused on the optical disc, and the objective lens may be moved at a speed memorized in the memorizing member. Thus, in a case of the small vertical deviation, when aligning the focus for the second time, the objective lens is moved at the speed memorized in the memory member. Thus, the time for aligning the focus can be reduced.

In a case that the light is not focused on the optical disc while the objective lens is moved in a specific range, when the optical disc having the largest vertical deviation is rotated, the controlling member may move the objective lens at a speed of enabling to align the focus with respect to the speed of the optical disc in the vertical direction. Thus, even in a worst-case condition, the objective lens is moved so slowly to align the focus. Therefore, the objective lens is moved while changing the speed to correspond to the vertical deviation to the end of the optical disc. Thus, the objective lens driving device can recover to align the focus when firstly aligning the focus cannot be carried out.

A method for driving the objective lens according to an embodiment of the present invention controls to move the objective lens faster as the objective lens is closer to a basic focusing position at which light is focused on an optical disc having no vertical deviation. Thus, in a position away from the basic focusing position when the optical disc has no vertical deviation, namely, in a position where a possibility to detect the focusing position when the optical disc has a large vertical deviation, the objective lens is allowed to move so slowly as to align the focus even when the optical disc has the large vertical deviation. In a position near the focusing position when the optical disc has no jiggle, namely, in a position where a possibility to detect the focusing position when the optical disc has a small jiggle, the objective lens is allowed to move so fast as to align the focus when the optical disc has a small vertical deviation. Therefore, the objective lens driving device can align the focus at a speed corresponding to an amount of the vertical deviation. Therefore, when the vertical deviation is small, time for aligning the focus can be reduced.

### First Embodiment

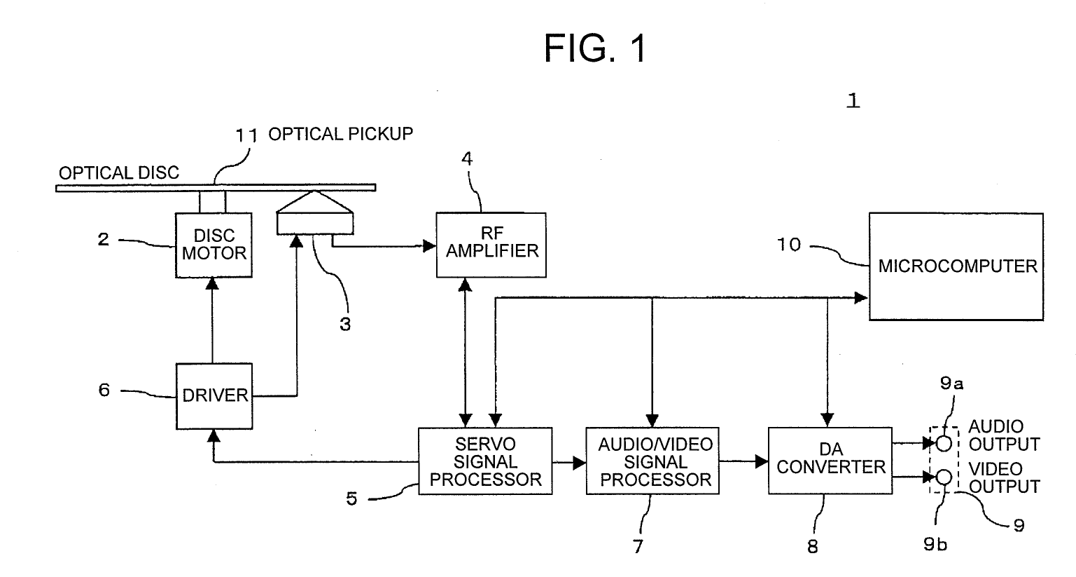

An optical disc player 1 as an objective lens driving device according to a first embodiment of the present invention will be explained with reference to FIGS. 1 to 5. The optical disc player 1 can reproduce an optical disc such as DVD (Digital Versatile Disc), CD (Compact Disc), BD (Blu-ray Disc). As shown in FIG. 1, the optical disc player 1 includes a disc motor 2, an optical pickup 3, an RF amplifier 4, a servo signal processor 5, a driver 6, an audio/video signal processor 7, a D/A converter 8, an audio/video signal output 9, and a microcomputer 10.

The disc motor 2 is a motor for rotating an optical disc 11 mounted on the optical disc player 1, and composed of a spindle motor and the like.

The optical pickup 3 includes: a not-shown laser diode as a light source for generating laser beam applied to the optical disc 11; an objective lens for applying the leaser beam onto the optical disc 11; an actuator for driving the objective lens for focusing or tracking corresponding to an instruction from the servo signal processor 5; and a photoreceiver for receiving light reflected from the optical disc 11. The optical pickup 3 generates and outputs signals including music and videos recorded on the 11 and various control signals such as a focus error signal from an output from the photoreceiver.

The RF amplifier 4 amplifies a signal inputted from the optical pickup 3 to a specific value and outputs to the servo signal processor 5.

The servo signal processor 5 as a driving member, the controlling member, and the memorizing member is composed of CPU (Central Processing Unit), RAM (Random Access Memory), and ROM (Read Only Memory). The servo signal processor 5 allows data recorded on the optical disc 11 to be read correctly by driving the objective lens of the optical pickup 3, controlling the focus and tracking, and setting the moving speed of the objective lens corresponding to the amount of the vertical deviation based on the control signals such as the focus error signal inputted from the RF amplifier 4. Further, the servo signal processor 5 converts analog signals of the music and videos recorded on the optical disc 11 to digital signals and outputs to the audio/video signal processor 7.

The driver 6 amplifies the signal inputted from the servo signal processor 5 and outputs to the disc motor 2 and the optical pickup 3.

The audio/video signal processor 7 decodes the signal inputted from the servo signal processor 5 to audio or video signal and corrects errors, then outputs to the D/A converter 8.

The D/A converter 8 converts the digital signal inputted from the audio/video signal processor 7 into the analog signal, and outputs through an audio output terminal 9a and a video output terminal 9b.

The microcomputer 10 is composed of CPU, RAM, and ROM, and controls the whole optical disc player 1 operations such as inserting and ejecting the optical disc 11, playing and stopping.

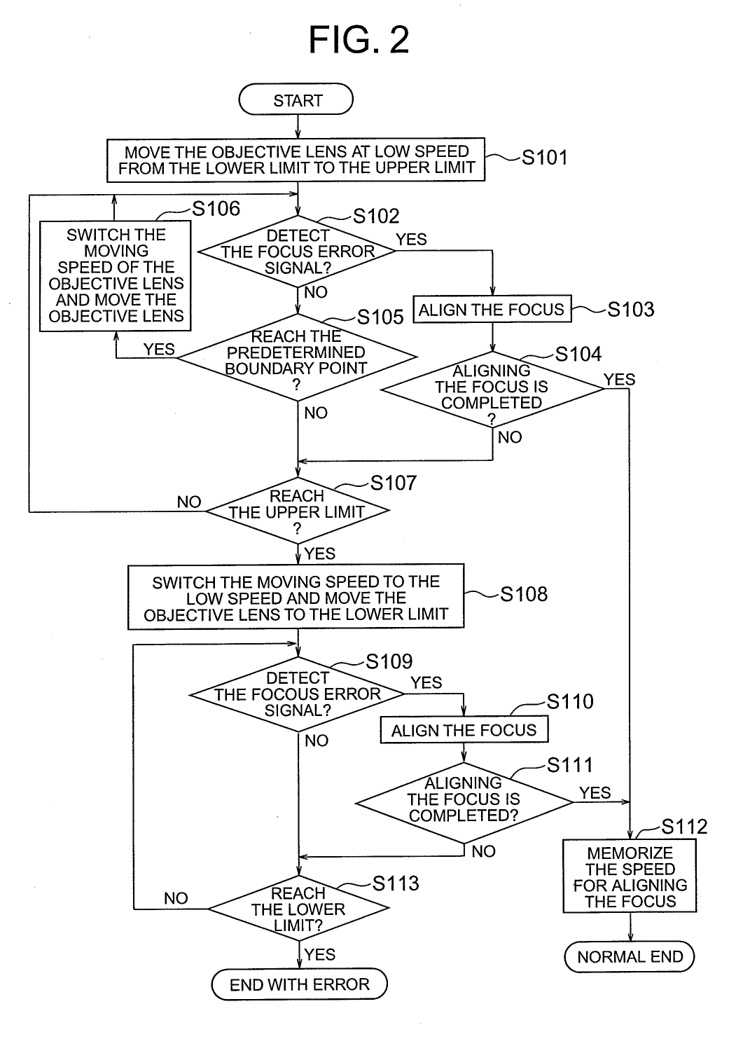

Next, in the optical disc player 1 having a structure shown in FIG. 1, an operation of determining the moving speed of the objective lens will be explained with reference to a flowchart shown in FIG. 2. The flowchart shown in FIG. 2 is realized when the CPU of the servo signal processor 5 carries out a control program memorized in ROM of servo signal processor 5.

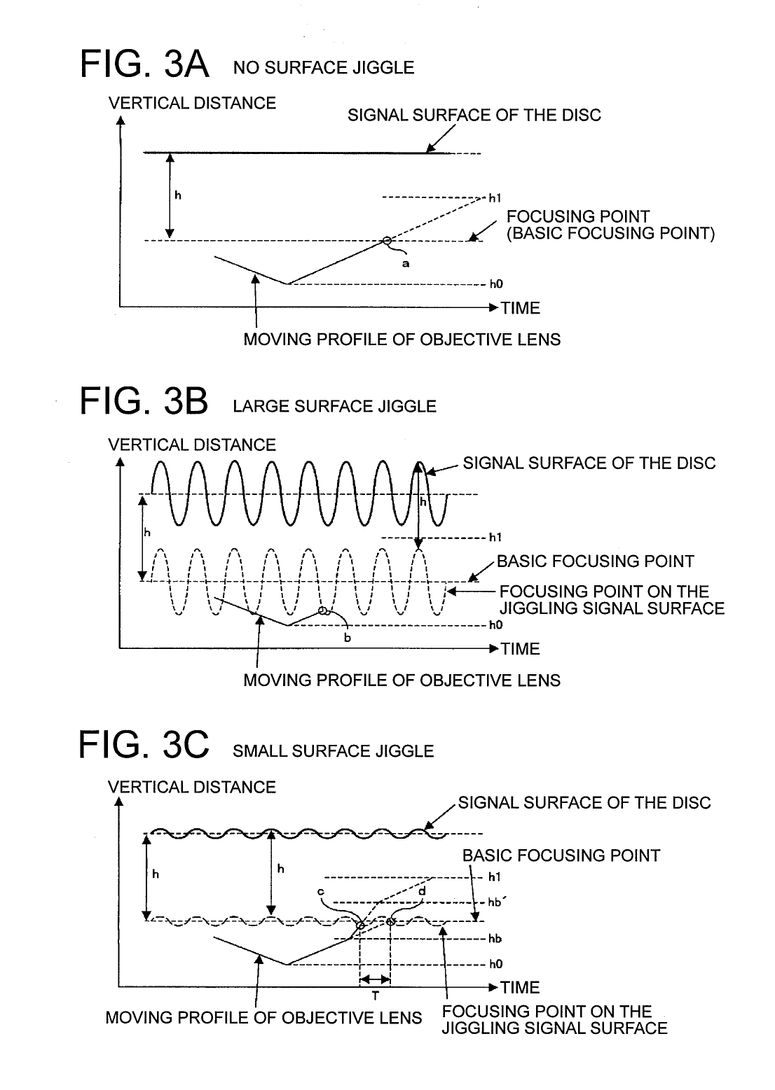

Now, an operation of aligning the focus by moving the objective lens will be explained with reference to FIG. 3. FIG. 3A is a case in which the optical disc 11 has no vertical deviation. As shown in FIG. 3A, in a case that the optical disc 11 has no vertical deviation, when the optical disc 11 is rotated, a surface of a cross section of the signal surface is completely flat, and arranged in the same plane. In this case, the focusing position where the light is focused on the signal surface of the optical disc 11 is also flat and a focusing distance is continuously “h”. Namely, this focusing position is the basic focusing position in claims. At this time, once the objective lens is moved downward to a lower limit “h0” of a specific range, then while laser beam is applied, the objective lens is moved upward to an upper limit “h1” of the specific range, so that aligning the focus is carried out. The moving speed of the objective lens at this time is indicated by a slope of a moving profile of the objective lens, because a horizontal axis is time and a vertical axis is distance in FIG. 3. The larger the slope is (closer to the vertical axis), the faster the moving speed is.

As the vertical deviation, when the optical disc 11 is rotated, the surface of the cross-section of the optical disc 11 is vertically oscillated. A large vertical deviation means a large width of the oscillation as shown in FIG. 3B. In this case, because a variation of a relative speed between the objective lens and the signal surface of the optical disc 11 is large, in a range where the objective lens can focus the laser beam on the optical disc having large vertical deviation, aligning the focus may not be carried out well unless at a slow speed for a worst case where the relative speed between the objective lens and the signal surface of the optical disc 11 is maximum. As shown in FIG. 3C, when the optical disc 11 has a small vertical deviation, because a variation of the signal surface of the optical disc 11 in the vertical direction is small, the variation of the relative speed between the objective lens and the signal surface of the optical disc 11 is small. Therefore, aligning the focus can be carried out at a speed faster than the slow speed for the worst case. Therefore, as shown in FIG. 3C, a boundary point “hb” is provided in the specific range in which the objective lens is moved. Then, if the focusing position is not detected while the objective lens is moved from the lower limit “h0” to a point over the boundary point “hb”, the optical disc player 1 judges that the optical disc 11 has a small vertical deviation, and moves the objective lens faster (a slope of the moving profile in FIG. 3C becomes larger). Thus, the objective lens reaching the focusing position “c” by moving faster from the boundary point “hb” is time “T” earlier than the objective lens reaching the focusing position “d” by moving continuously at low speed. Therefore, the time for aligning the focus is reduced. Here, the time for moving the objective lens from the lower limit “h0” to the boundary point “hb” is set to be sufficiently later than a rotational period of the optical disc 11. Further, the moving speed of the objective lens is so set as to align the focus even under the worst case condition that the relative speed between the objective lens and the disc signal surface is the maximum, when the objective lens moving in this range focuses the laser beam on the optical disc 11 having large vertical deviation. Thus, in this range, aligning the focus is carried out with respect to the optical disc 11 having large vertical deviation. Further, from the boundary point “hb”, the moving speed of the objective lens is so set to be larger than before, and to allow to align the focus even when the relative speed between the objective lens and the optical disc 11 having small vertical deviation is the maximum. Thus, aligning the focus is carried out with respect to the optical disc 11 having small surface juggle. The operation described the above will be explained in detain with reference to the flowchart of FIG. 2.

Firstly, in step S10, after the objective lens of the optical pickup 3 is once moved to the lower limit “h0” in the specific range of the objective lens, the control signal for moving the objective lens to the upper limit “h1” in the specific range at so slow speed as to align the focus even under the predetermined worst case condition while applying the laser beam is outputted through the driver 6 to the optical pickup 3. Then, the flow goes to step S102. Namely, the objective lens is moved toward the basic focusing position from a position far from the basic focusing position. Incidentally, the specific range is a range in which the objective lens is moved while the laser beam from the laser diode is applied for sufficiently detecting the focusing position of the optical disc 11, such as from the bottom dead center to the top dead center.

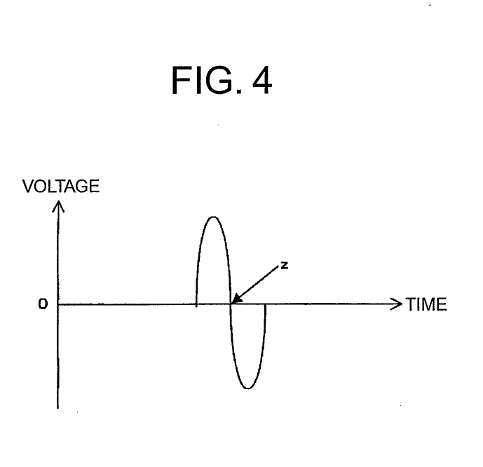

Next, in step S102, when the signal surface of the optical disc 11 passes over the focusing position, whether the focus error signal outputted from the optical pickup 3 is detected or not is judged. When the focus error signal is detected (“Yes” in step S102), the flow goes to step S103, when the focus error signal is not detected (“No” in step S102), the flow goes to step S105. The focus error signal is a waveform (S curve) shown in FIG. 4, and a zero cross point “z” indicates a point where the laser beam completely comes into focus.

Next, in step S103, it is judged that the focus error signal is detected, namely, the objective lens reaches the focusing position, and aligning the focus is carried out. Then, the flow goes to step S104. When this step is carried out before the objective lens reaches the focusing position, the objective lens is moved at low speed to align the focus. Therefore, it is supposed that the optical disc 11 has large vertical deviation, namely, a case shown in FIG. 3B. For aligning the focus, the control signal to stop the objective lens around the zero cross point “z” in the S curve of FIG. 4 is outputted through the driver 6 to the optical pickup 3.

Next, in step S104, whether aligning the focus is completed or not is judged. When aligning the focus is completed (“Yes” in step S104), the flow goes to step S112. When aligning the focus is not completed (“No” in step S104), the flow goes to step S107. Here, to complete aligning the focus means to stop the objective lens around the zero cross point “z”. If the objective lens is too far from the zero cross point “z”, the laser beam may be out of focus, or easy to be out of focus owing to a little disturbance. Therefore, if the objective lens is not stopped around the zero cross point “z”, aligning the focus is judged as not completed, and the objective lens is moved again.

In step S105, whether the objective lens reaches the boundary point (“hb” in FIG. 3C) which is positioned in the specific range of the objective lens for changing the moving speed of the objective lens, and previously stored in ROM of servo signal processor 5 or not is judged. If the objective lens reaches the boundary point (“Yes” in step S105), the flow goes to step S106, and if not (“No” in step S105), the flow goes to step S107.

Next, in step S106, the moving speed of the objective lens is switched from the slow speed to allow to align the focus even under the worst case condition to the faster speed, and the flow goes to step S102. Namely, when the objective lens is positioned nearer the basic focusing position than the boundary point, the moving speed of the objective lens is higher than when the objective lens is positioned further the basic focusing position than the boundary point.

Next, in step S107, whether the objective lens reaches the upper limit (“h1” in FIG. 3C) in the specific range where the objective lens is moved or not is judged. If the objective lens reaches the upper limit (“Yes” in step S107), the flow goes to step S108, and if not (“No” in step S107), the flow goes back to step S102.

In a case that once the step S106 is carried out and the objective lens is judged not to reach the upper limit in step S107, and the flow goes back to step S102, if the focus error signal is detected and the flow goes to step S103 and S104, because the objective lens is moved at high speed and aligning the focus is carried out, it is supposed that the optical disc 11 has small vertical deviation, namely, a case shown in FIG. 3C. For aligning the focus, similar to step S103, the control signal to stop the objective lens around the zero cross point “z” in the S curve of FIG. 4 is outputted through the driver 6 to the optical pickup 3.

Next, in step S108, after the moving speed of the objective lens is switched to the slow speed, while the laser beam is applied, the control signal to move the objective lens to the lower limit “h0” in the specific range at the low speed is outputted through the driver 6 to the optical pickup 3, and the flow goes to step S109. Namely, after the objective lens is moved from one end to the other end in the specific range, the objective lens is moved from the other end to the one end at the slow speed to allow to align the focus even under the worst case condition (the speed to allow the laser beam to focus on the rotated optical disc 11 having the largest vertical deviation with respect to the moving speed of the rotated optical disc 11 in the vertical direction).

Next, in step S109, the focus error signal outputted from the optical pickup 3 when the signal surface of the optical disc 11 passes over the focusing position is detected or not is judged. If the focus error signal is detected (“Yes” in step S109), the flow goes to step S110, and if not (“No” in step S109), the flow goes to step S113.

Next, in step S110, it is judged that the focus error signal is detected, namely, the objective lens reaches the focusing position, and aligning the focus is carried out. Then, the flow goes to step S111. Similar to step S103, for aligning the focus, the control signal to stop the objective lens around the zero cross point “z” in the S curve of FIG. 4 is outputted through the driver 6 to the optical pickup 3.

Next, in step S111, whether aligning the focus is completed or not is judged. When aligning the focus is completed (“Yes” in step S111), the flow goes to step S112. When aligning the focus is not completed (“No” in step S111), the flow goes to step S113.

Next, in step S112 as the memorizing member, the moving speed (low or high speed) of the objective lens when aligning the focus is completed is memorized in RAM of the servo signal processor 5, and the flow ends.

In step S113, whether the objective lens reaches the lower limit “h0” in the specific range or not is judged. If the objective lens reaches the lower limit (“Yes” in step S113), the flow ends with error, and if not (“No” in step S113), the flow goes back to step S109. When the flow ends with error, this flowchart is carried out again with a widened specific range, or if there is no room for widening the specific range, for example, error notification is sent to the user, the optical disc 11 is ejected, and the flow ends.

Incidentally, in the explanation above, the boundary point is provided between the lower limit of the specific range where the objective lens is moved and the basic focusing position. However, another boundary point (“hb” in FIG. 3) may be provided between the basic focusing position and the upper limit in the specific range, and the moving speed of the objective lens may be switched to the slow speed when the objective lens passes over the another boundary point. In this case, in the flowchart of FIG. 2, in step S106, when the objective lens passes over the basic focusing position, the moving speed of the objective lens may be controlled to be switched to the slow speed.

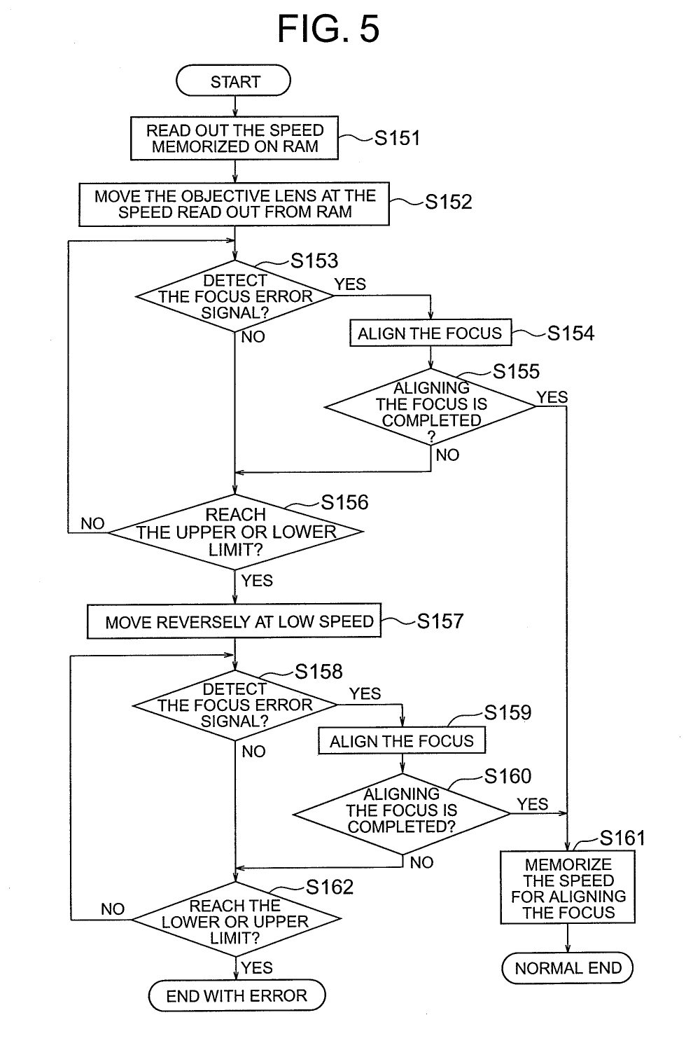

Next, an operation of aligning the focus using the moving speed memorized in step S112 when the reproducing is started again after the reproducing is stopped after reproducing videos and sounds after the operation of aligning the focus is normally ended in the flowchart of FIG. 2 will be explained with reference to a flowchart of FIG. 5.

Firstly, in step S151, the moving speed (low or high speed) of the objective lens memorized in RAM of the servo signal processor 5 in step S112 of FIG. 2 is read out from RAM.

Next, in step S152, after once the objective lens of the optical pickup 3 is moved to the lower limit “h0”, while the laser beam is applied, the control signal to move the objective lens to the upper limit “h1” at the speed read out from RAM is outputted through the driver 6 to the optical pickup 3, and the flow goes to step S153.

Next, in step S153, whether the focus error signal outputted from the optical pickup 3 when the signal surface of the optical disc 11 passes over the focusing position is detected or not is judged. If the focus error signal is detected (“Yes” in step S153), the flow goes to step S154, and if not (“No” in step S153), the flow goes to step S156.

Next, in step S154, it is judged that the focus error signal is detected, namely, the objective lens reaches the focusing position, and aligning the focus is carried out. Then, the flow goes to step S155. For aligning the focus, the control signal to stop the objective lens around the zero cross point “z” in the S curve of FIG. 4 is outputted through the driver 6 to the optical pickup 3. Namely, aligning the focus with respect to the optical disc 11 is carried out by moving the objective lens at the moving speed memorized in the memorizing member.

Next, in step S155, whether aligning the focus is completed or not is judged. When aligning the focus is completed (“Yes” in step S155), the flow goes to step S161. When aligning the focus is not completed (“No” in step S155), the flow goes to step S156.

Next, in step S156, whether the objective lens reaches the upper limit “h1” or not is judged. If the objective lens reaches the upper limit (“Yes” in step S156), the flow goes to step S157, and if not (“No” in step S156), the flow goes back to step S153.

Next, in step S157, after the moving speed of the objective lens is switched to the slow speed, while the laser beam is applied, the control signal to move the objective lens to the lower limit “h0” at the low speed is outputted through the driver 6 to the optical pickup 3, and the flow goes to step S158.

Next, in step S158, whether the focus error signal outputted from the optical pickup 3 when the signal surface of the optical disc 11 passes over the focusing position is detected or not is judged. If the focus error signal is detected (“Yes” in step S158), the flow goes to step S159, and if not (“No” in step S158), the flow goes to step S162.

Next, in step S159, it is judged that the focus error signal is detected, namely, the objective lens reaches the focusing position, and aligning the focus is carried out. Then, the flow goes to step S160. For aligning the focus, similar to step S154, the control signal to stop the objective lens around the zero cross point “z” in the S curve of FIG. 4 is outputted through the driver 6 to the optical pickup 3.

Next, in step S160, whether aligning the focus is completed or not is judged. When aligning the focus is completed (“Yes” in step S160), the flow goes to step S161. When aligning the focus is not completed (“No” in step S160), the flow goes to step S162.

Next, in step S161, the moving speed (low or high speed) of the objective lens when aligning the focus is completed is memorized in RAM of the servo signal processor 5, and the flow ends.

In step S162, whether the objective lens reaches the lower limit “h0” in the specific range or not is judged. If the objective lens reaches the lower limit (“Yes” in step S162), the flow ends with error, and if not (“No” in step S162), the flow goes back to step S158. When the flow ends with error, similar to step S113 of FIG. 3, this flowchart is carried out again with a widened specific range, or if there is no room for widening the specific range, for example, error notification is sent to the user, the optical disc 11 is ejected, and the flow ends.

According to this embodiment, in a case that the optical disc 11 has no vertical deviation in the lower limit to the upper limit, when the objective lens is moved to the focusing position, firstly, the objective lens is moved at low speed so that even under the worst case condition, aligning the focus can be carried out. Then, when the objective lens reaches the boundary point nearer the basic focusing position than the lower limit, the objective lens is moved at high speed. Thus, the time for detecting the focusing position is shorter than when the objective lens is continuously moved at low speed. Therefore, the time for aligning the focus is reduced. Further, because the moving speed of the objective upon aligning the focus is memorized in RAM of the servo signal processor 5, when the reproduce starts again, the objective lens is moved at the speed memorized in RAM unless the optical disc 11 is ejected from the optical disc player 1. Therefore, when the vertical deviation is small, and the objective lens is moved at high speed upon aligning the focus, the time for aligning the focus is reduced.

Incidentally, in this embodiment, boundary points are provided between the basic focusing position and the lower limit, and between the upper limit and the basic focusing position in the specific range where the objective lens is moved. However, a plurality of boundary points may be provided. In this case, the moving speed of the objective lens in between the boundaries is set faster as the objective lens is positioned nearer the basic focusing position.

### Second Embodiment

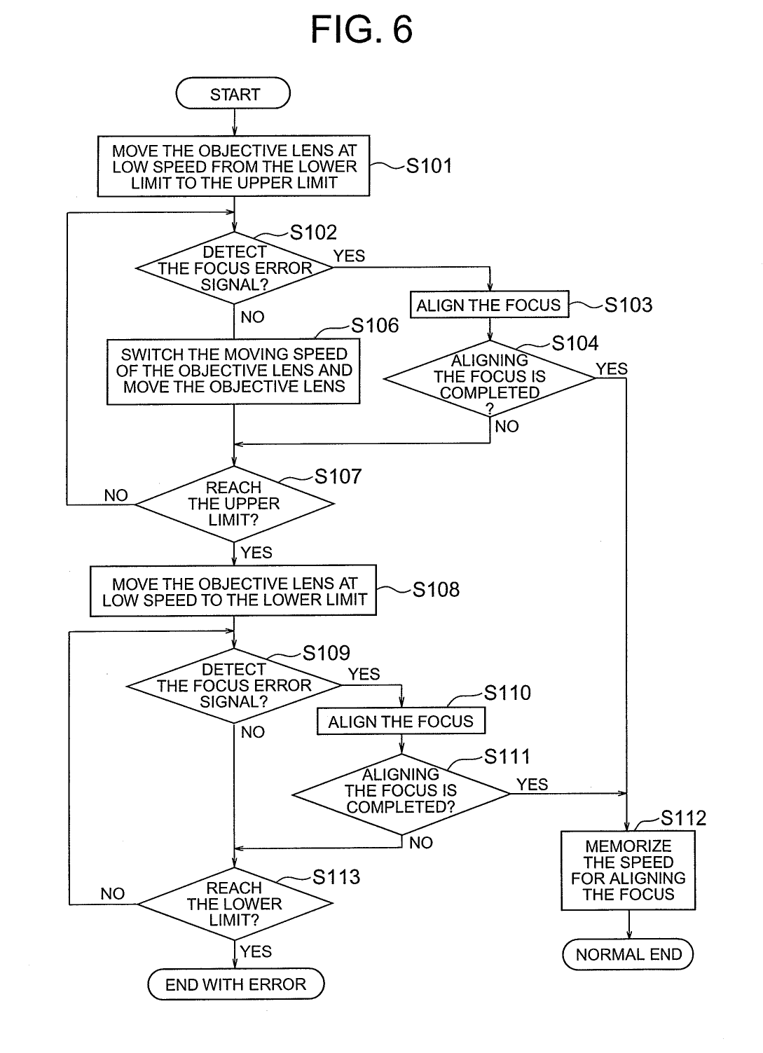

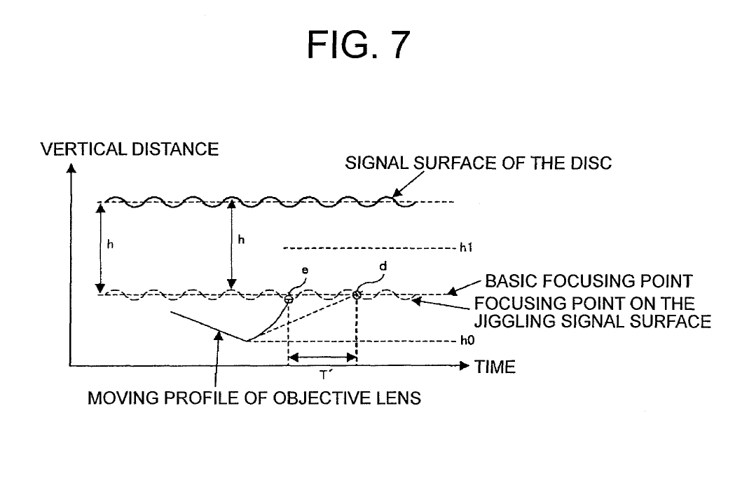

Next, the optical disc player 1 as the objective lens driving device according to a second embodiment of the present invention will be explained with reference to FIGS. 6 and 7. The parts same as the first embodiment is indicated by the same reference numerals, and the explanations thereof are omitted.

A structure in this embodiment is the same as the first embodiment. In the first embodiment, the boundary point is provided in the specific range where the objective lens is moved, and when the objective lens passes the reference point, the moving speed of the objective lens is changed. In the second embodiment, the moving speed of the objective lens is gradually faster as the objective lens is positioned nearer the basic focusing position. For this purpose, a control program of the servo signal processor 5 is partially changed. FIG. 6 shows a flowchart for aligning the focus by moving the objective lens according to this embodiment.

Steps S101 to S104 are same as in the first embodiment. In step S106′, the moving speed is changed higher than before, and the flow goes to step S107. At this time, the boundary point of the first embodiment is unnecessary. Every time this step is carried out, the moving speed is gradually higher so that as shown in FIG. 7, the moving speed can be changed in no step or in multi step. Therefore, aligning the focus is carried out at time T′ shorter at the focusing position “e” than at the focusing position “d” when the objective lens is conventionally continuously at low speed. Further, if the objective lens passes over the basic focusing position without detecting the focusing position, the moving speed of the objective lens is controlled to be slower as the objective lens is further away from the basic focusing position. Thus, aligning the focus can be carried out at the speed corresponding to the amount of vertical deviation in between the basic focusing position and the upper limit.

Next, steps after step S107 are the same as the first embodiment. Further, because in step S112, the moving speed of the objective lens is memorized in RAM similar to the first embodiment, when the reproduce starts again, the flowchart of FIG. 5 may be carried out.

According to this embodiment, when the objective lens is moved toward the basic focusing position from the lower limit, firstly, the moving speed is faster than the speed for the worst case condition considering the case that the optical disc 11 has small vertical deviation, then, the moving speed is gradually faster as the objective lens is positioned nearer the focusing position when the optical disc 11 has no vertical deviation. Thus, the time for detecting the focusing position is shorter than when the objective lens is continuously moved at low speed for the worst case condition. Therefore, the time for aligning the focus is reduced.

Incidentally, in this embodiment, the objective lens is moved from the lower limit to the upper limit. However, the objective lens may moved from the upper limit to the lower limit.

Further, in this embodiment, the focus error signal is used as the detected signal when the focusing position passes over the signal surface of the optical disc 11. However, other signals such as return light sum signal or RF signal generated by the optical pickup 3 and detected by the servo signal processor 5 when the focusing position passes over the signal surface of the optical disc 11 can be used. Further, a plurality of these signals can be detected and a combination of detecting results can be used for judging the amount of vertical deviation of the optical disc 11.

Further, according to this embodiment, the optical disc player 1 can be used for DVD, CD, and BD. However, the optical disc player 1 can be used for other optical discs such as HD-DVD.

According to the embodiments above, the objective lens driving unit and the driving method of the same described hereafter can be attained.

(Note 1)

The optical disc player 1 including:

the laser diode;

the objective lens for focusing light from the laser diode on the optical disc 11;

the servo signal processor 5 for moving the objective lens with respect to the optical lens 11 in a vertical direction,

the optical disc player 1 further including the servo signal processor 5 for allow the servo signal processor 5 to move the objective lens in a specific range so as to focus light from the laser diode on the optical disc 11, namely, to align the focus,

wherein when aligning the focus, the servo signal processor 5 controls the servo signal processor 5 to move the objective lens faster as the objective lens is positioned closer to a basic focusing position at which the light is focused on the optical disc 11 having no vertical deviation.

According to this optical disc player 1, in a position where a possibility to detect the focusing position when the optical disc has a small jiggle, the objective lens is allowed to move so fast as to align the focus when the optical disc has a small vertical deviation. Therefore, the objective lens driving device can align the focus at a speed corresponding to an amount of the vertical deviation. Therefore, when the vertical deviation is small, time for aligning the focus can be reduced.

(Note 2)

An objective lens driving method for moving an objective lens with respect to the optical disc 11 in a vertical direction, said objective lens being used for focusing light from the laser diode on the optical disc 11,

wherein when moving the objective lens in a specific range so as to focus the light from the laser diode on the optical disc 11, namely, when aligning the focus, the method allows to move the objective lens faster as the objective lens is positioned closer to a basic focusing position at which the light is focused on the optical disc 11 having no vertical deviation.

According to this objective lens driving method, in a position where a possibility to detect the focusing position when the optical disc has a small jiggle, the objective lens is allowed to move so fast as to align the focus when the optical disc has a small vertical deviation. Therefore, the objective lens driving device can align the focus at a speed corresponding to an amount of the vertical deviation. Therefore, when the vertical deviation is small, time for aligning the focus can be reduced.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

1. An objective lens driving device comprising:
a light source;
an objective lens for focusing light from the light source on an optical disc;
a driving member for moving the objective lens with respect to the optical lens in a substantially vertical direction,
a controlling member for allowing the driving member to move the objective lens in a specific range so as to align the focus to focus light from the light source on the optical disc,
wherein when aligning the focus, the control member controls the driving member to move the objective lens faster as the objective lens is positioned closer to a basic focusing position at which the light is focused on the optical disc having no vertical deviation.

2. The objective lens driving device as claimed in claim 1,
wherein when the driving member moves the objective lens away from the basic focusing position, the controlling member controls to move slower the objective lens as the objective lens is positioned further from the basic focusing position.

3. The objective lens driving device as claimed in claim 1,
wherein the controlling member provides a boundary point in the specific range, and moves faster the objective lens when the objective lens is positioned nearer the basic focusing position than the boundary point than when the objective lens is positioned further the basic focusing position than the boundary point.

4. The objective lens driving device as claimed in claim 3,
wherein the controlling member provides a plurality of boundary points in the specific range, and every time the objective lens passes over one of the boundary points, the control member changes a moving speed of the objective lens.

5. The objective lens driving device as claimed in claim 1,
further comprising a memorizing member to memorize a moving speed of the objective lens when the light is focused on the optical disc,
wherein the controlling member moves the objective lens at a speed memorized in the memorizing member to align the focus with respect to the optical disc.

6. The objective lens driving device as claimed in claim 1,
wherein when the light is not focused on the optical disc while the objective lens is moved in the specific range, the controlling member moves the objective lens at a speed to allow the light to be focused on the optical disc with respect to a speed of the optical disc in a vertical direction when the optical disc having the maximum vertical deviation is rotated.

7. An objective lens driving method for moving an objective lens with respect to an optical disc in a substantially vertical direction, said objective lens being used for focusing light from a light source on the optical disc,
wherein when aligning the focus to the objective lens in a specific range so as to focus the light from the light source on the optical disc, the objective lens is allowed to move faster as the objective lens is positioned closer to a basic focusing position at which the light is focused on the optical disc having no vertical deviation.
